(19) United States
(12) Patent Application Publication
(10) Pub. No.: US 2014/0090386 A1
(43) Pub. Date: Apr. 3, 2014

(54) GEARED TURBOFAN WITH FAN AND CORE MOUNTED ACCESSORY GEARBOXES

(71) Applicants: Thomas G. Cloft, Glastonbury, CT (US); Robert L. Gukeisen, Middletown, CT (US); Claude Mercier, South Windsor, CT (US)

(72) Inventors: Thomas G. Cloft, Glastonbury, CT (US); Robert L. Gukeisen, Middletown, CT (US); Claude Mercier, South Windsor, CT (US)

(73) Assignee: UNITED TECHNOLOGIES CORPORATION, Hartford, CT (US)

(21) Appl. No.: 13/630,279

(22) Filed: Sep. 28, 2012

(51) Int. Cl. F02C 6/00; F02C 3/04

(52) U.S. Cl. 60/772; 60/801

(57) ABSTRACT

A disclosed accessory drive system provides for the reduction in the overall diameter of the outer nacelle by splitting the number of accessory components between a first gear box mounted within the outer nacelle and a second gearbox mounted to the core engine. The first gear box mounted to the fan case of the gas turbine engine drives a first plurality of accessory components. The second gear box mounted to a core engine case of the gas turbine engine drives a second plurality of accessory components.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

The geared architecture provides for increased bypass ratio, that in turn increases overall size of the fan section and thereby the outer nacelle structure circumscribing the fan. Prior gas turbine engines mounted auxiliary gearboxes in the outer nacelle structure. Such auxiliary gearboxes are utilized to drive systems such as aircraft environmental controls, generators in addition to engine specific systems such as lubricant systems.

Nacelle outer diameter and vertical height are important considerations for a turbine engine manufacturer and therefore it is desirable to pursue improvements that limit the overall size of the nacelle without sacrificing the advantages provided by the increased overall size of the fan section.

### SUMMARY

An accessory drive system for a gas turbine engine according to an exemplary embodiment of this disclosure, among other possible things includes a first gear box mounted to a fan case of the gas turbine engine. The first gear box drives a first plurality of accessory components. A second gear box is mounted to a core engine case of the gas turbine engine. The second gear box drives a second plurality of accessory components. At least one of the first gear box and the second gear box is driven by a respective at least one shaft driven by the gas turbine engine.

In a further embodiment of the foregoing accessory drive system, includes a drive linkage between the first gear box and the second drive gear box. One of the first gear box and the second gear box drives the other gear box through the drive linkage.

In a further embodiment of any of the foregoing accessory drive systems, the first gear box is driven by the shaft of the gas turbine engine and the second gear box is driven through the drive linkage.

In a further embodiment of any of the foregoing accessory drive systems, the second gear box is driven by the shaft of the gas turbine engine and the second gear box is driven through the drive linkage.

In a further embodiment of any of the foregoing accessory drive systems, the shaft driven by the gas turbine engine includes a first shaft driving the first gear box and a second shaft driving the second gear box.

In a further embodiment of any of the foregoing accessory drive systems, the second plurality of components driven by the second gear box operate within a second predetermined operating range at a temperature greater than a first predetermined operating range of the first plurality of components driven by the first gear box.

In a further embodiment of any of the foregoing accessory drive systems, the first plurality of components driven by the first gear box are accessed more frequently than the second plurality of components.

A gas turbine engine according to an exemplary embodiment of this disclosure, among other possible things includes a fan including a plurality of fan blades rotatable about an axis, and a fan case circumscribing the fan. A core engine section includes a core case structure supporting a compressor section, a combustor in fluid communication with the compressor section, a turbine section in fluid communication with the combustor, and a geared architecture driven by the turbine section for rotating the fan about the axis. An accessory drive system includes a first gear box mounted to the fan case of the gas turbine engine. The first gear box drives a first plurality of accessory components, and a second gear box mounted to the core case structure. The second gear box drives a second plurality of accessory components. At least one of the first gear box and the second gear box is driven by a respective at least one shaft driven by the core engine section.

In a further embodiment of the foregoing gas turbine engine, the shaft includes a tower shaft driven by the turbine section.

In a further embodiment of any of the foregoing gas turbine engines, includes a drive linkage between the first gear box and the second drive gear box. One of the first gear box and the second gear box drives the other gear box through the drive linkage.

In a further embodiment of any of the foregoing gas turbine engines, the first gear box is driven by the shaft of the gas turbine engine and the second gear box is driven through the drive linkage.

In a further embodiment of any of the foregoing gas turbine engines, the second gear box is driven by the shaft of the gas turbine engine and the second gear box is driven through the drive linkage.

In a further embodiment of any of the foregoing gas turbine engines, the tower shaft driven by the gas turbine engine includes a first tower shaft driving the first gear box and a second tower shaft driving the second gear box.

In a further embodiment of any of the foregoing gas turbine engines, the second plurality of components driven by the second gear box operate within a second predetermined range at a temperature greater than a first predetermined operating range of the first plurality of components driven by the first gear box.

In a further embodiment of any of the foregoing gas turbine engines, the first plurality of components driven by the first gear box are accessed more frequently than the second plurality of components.

A method of driving accessories of a gas turbine engine according to an exemplary embodiment of this disclosure, among other possible things includes mounting a first gear box to a fan case of a gas turbine engine, mounting a second gear box apart from the first gear box to a core engine case structure of the gas turbine engine, and driving at least one of the first gear box and the second gear box with a respective at least one shaft powered by a shaft of the gas turbine engine.

In a further embodiment of the foregoing method, includes driving one of the first gear box and the second gear box not driven by shaft of the gas turbine engine through a drive linkage between the first gear box and the second gear box.

In a further embodiment of any of the foregoing methods, includes driving a first plurality of components with the first gear box that are accessed more frequently than a second plurality of components driven by the second gear box.

In a further embodiment of any of the foregoing methods, includes driving a second plurality of components with the second gear box that operate within a second predetermined operating range at a temperature greater than a first predetermined operating range of a first plurality of components driven by the first gear box.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2A is a schematic view of another example gas turbine engine.

FIG. 2B is a front schematic view of the example gas turbine engine.

FIG. 3A is another schematic view of an example gas turbine engine.

FIG. 3B is a front view of the example gas turbine engine shown in FIG. 3A.

### DETAILED DESCRIPTION

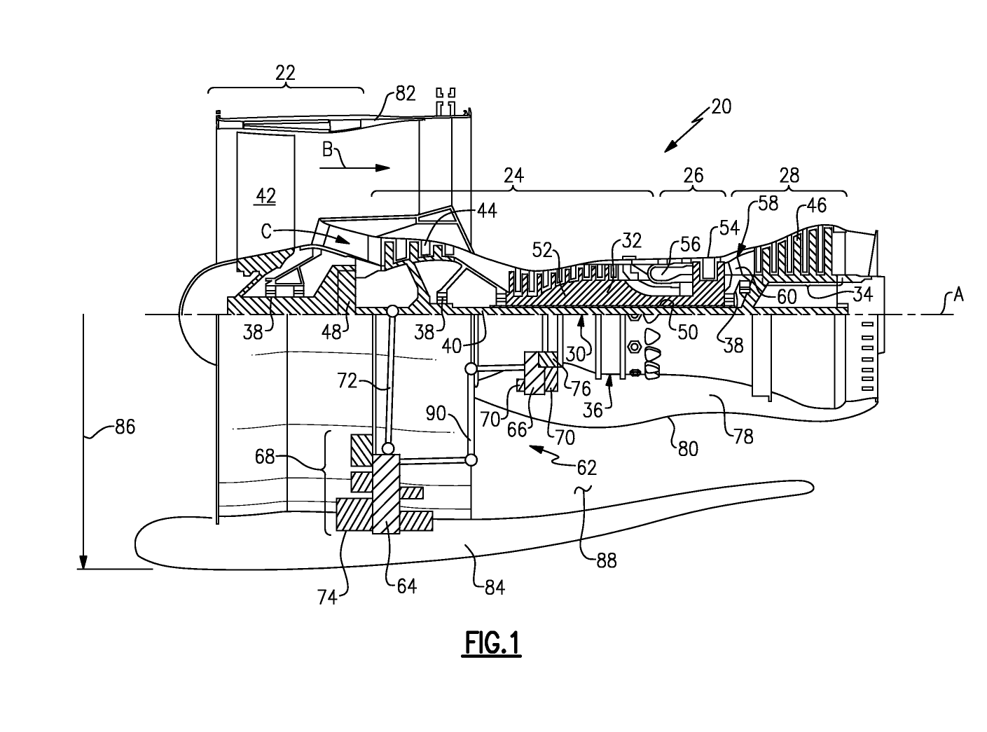

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram °R)/(518.7° R)]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

A fan case 82 surrounds the fan 42 and supports a portion of an accessory drive system 62. The accessory drive system 62 includes a first gearbox 64 and a second gearbox 66. The gearboxes 64, 66 drive accessory components that are utilized to drive accessory systems of the gas turbine engine 20. In this example, such accessory systems can include pumps to drive a fan drive gear lubrication system as is schematically illustrated at 76 along with a generator 74 that is utilized for powering airframe electrical systems.

The example gas turbine engine 20 includes the geared architecture 48 to drive the fan blades 42. The geared architecture 48 provides for a larger diameter fan 42 with a larger bypass duct 88. The increase in fan diameter and larger bypass duct 88 improves efficiency of the gas turbine engine 20. The larger diameter fan 42 also results in a larger outer diameter 86 of the outer nacelle structure 84. The increased diameter of the gas turbine engine nacelle structure 84 is desired to be minimized to simplify mounting structures and locations on an airframe.

The accessory drive system 62 is typically mounted to the fan case 82 and can result in an increased diameter of the outer nacelle structure 84. In the disclosed example gas turbine engine 20, the accessory drive system 62 is split between being mounted on the fan case 82 and within an inner nacelle 80 surrounding a core engine structure 36 that reduces the overall diameter 86 of the outer nacelle 84.

In this example, the first gearbox 64 is mounted to the fan case 82 and drives a first plurality of accessory components 74. One of those accessory components driven by the first gearbox 64 is the generator 74 that generates electricity for the aircraft.

A second gearbox 66 is driven through a linkage 90 and is mounted on the core engine structure 36. The second gearbox 66 drives those components that are utilized for operation of the core engine section 78. In this example one of the second plurality of accessory components driven by the second gearbox 66 includes a fan drive gear lubrication system 76. It should be understood, that although the generator 74 and the fan drive gear lubrication system 76 are disclosed by way of example, each of the first and second gearboxes 64 and 66 may drive additional devices and components required for aircraft and engine operation.

In this disclosed example embodiment, the first gearbox 64 is driven through a tower shaft 72 that extends from and is driven by the inner shaft 40 of the low spool 30. The first gearbox 64 in turn drives the second gearbox 66 through the linkage 90. In this example, the linkage 90 comprises a shaft and geared connections that transmit torque from the first gearbox 64 to the second gearbox 66.

Each of the gearboxes 64 and 66 includes internal gearing to drive each of the specific accessory components 68, 70 at a speed required for desired operation. Further, each of the gearboxes 64 includes a plurality of gears providing the desired reductions and torque utilized to drive each of the specific accessory components 68, 70.

The division of the first plurality of accessories 68 from the second plurality of accessories 70 provides a reduced cross-section and volume of the first gearbox 64 mounted to the fan case 82. The reduction in size of the first gearbox 64 reduces the size required for the nacelle structure 84 that in turn reduces the outer diameter 86 of the nacelle 84. Moreover, the splitting of the accessory drive system 62 into the first gearbox 64 mounted on the fan case 82 and the second gearbox 66 mounted on the core engine structure 36 allows for the preferential placement of specific accessory components based on their operational and maintenance requirements.

Those accessory components mounted to the fan case 82 are most easily accessible as only panels on the outer nacelle structure 84 need be removed to provide access. The first plurality of accessory components 68 are selected from a group of components that may be maintained or otherwise are desired to be accessed in greater frequency than those that are mounted and driven by the second gearbox 66 mounted to the core engine 78.

Further, the second plurality of accessory components that are mounted to the static structure 36 of the engine core 78 encounter elevated temperatures and harsher environmental conditions than would be expected to be experienced by those components mounted to the fan case 82. The second plurality of accessory components 66 are therefore selected to include those components that require less maintenance and that are less sensitive to the harsher temperatures and environment encountered proximate to the core engine 78.

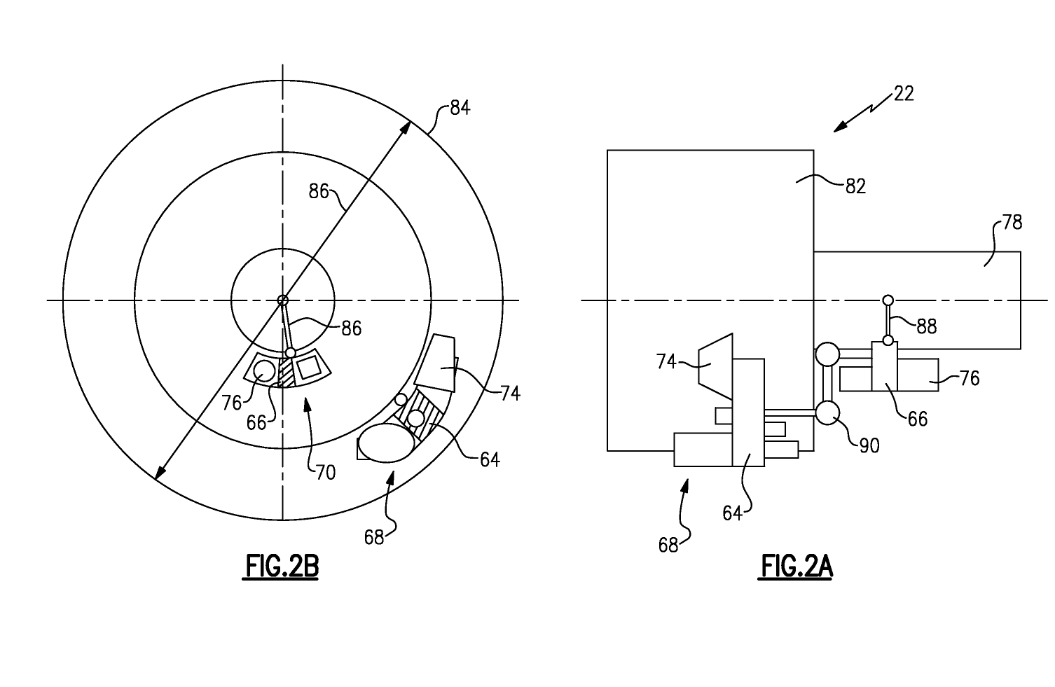

Referring to FIGS. 2A and 2B, another disclosed example gas turbine engine embodiment includes the first gearbox 64 and the second gearbox 66 with the second gearbox 66 driven by a tower shaft 88. The second gearbox 66 drives the first gearbox 64 through the linkage 90. The position of the first gearbox 64 and the second gearbox 66 can provide for the alternate location of a tower shaft 88 to drive each of the gearboxes 64, 66. The specific orientation and connection between the tower shaft 88 and the shaft 40 driven by the core engine 78 can be as is known in the art and also may be configured to take advantage of the relative positions of the accessory gearbox 66, 64 as they are mounted to the case 36 structures of the gas turbine engine 20.

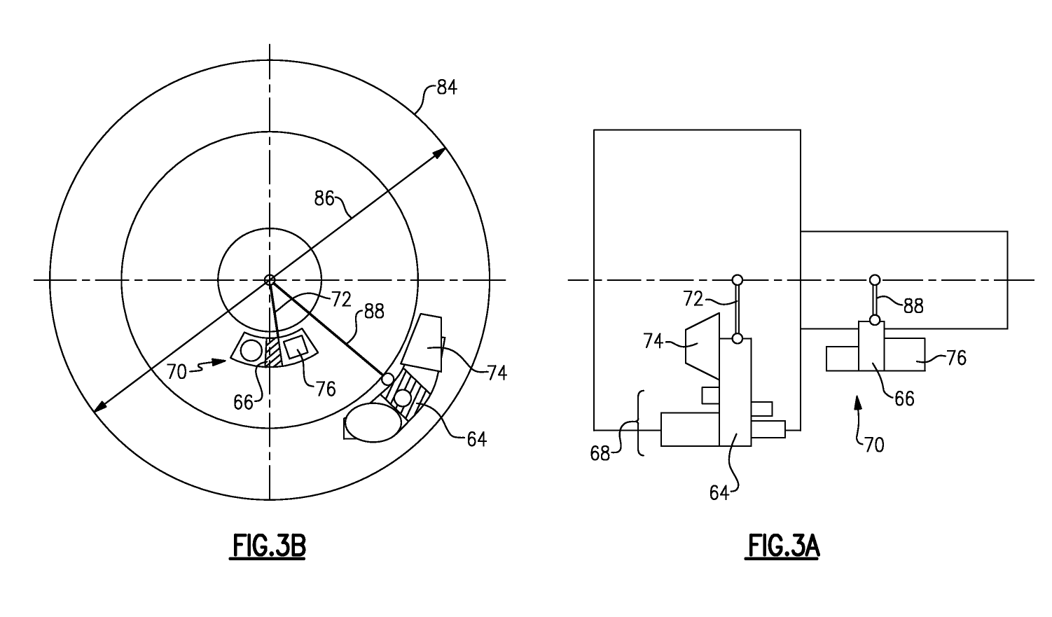

Referring to FIGS. 3A and 3B, another example gas turbine engine 20 is disclosed schematically and includes the accessory drive system 62 including the first gearbox 64 and the second gearbox 66. As described in the embodiment shown in FIG. 1, the first gearbox 64 drives the second gearbox 66 through the drive linkage 90. In the example embodiment disclosed in FIGS. 3A and 3B, each of the first gearbox 64 and the second gearbox 66 are driven through separate tower shafts 72, 88. In this example, the first tower shaft 72 drives the first gearbox 64 that is mounted on the fan case 82. A second tower shaft 88 extends from the core engine section 78 and drives the second gearbox 66. As appreciated, each of the tower shafts 72, 88 may be driven by the inner shaft 40 of the low spool 30, or by the outer shaft 50 of the high spool 32, or a combination of both the high and low spools 32, 30. The example tower shafts 72 and 88 are shown schematically and include specific gear structures required to communicate power and torque from the core engine 78 to the corresponding gearboxes 64, 66.

Accordingly, the example accessory drive system 62 provides for the reduction in the overall diameter 86 of the outer nacelle 84 about the fan case 82 within the fan section 22 by splitting the number of accessory components that are driven by each of the gearboxes 64, 66, the number of accessory components 68 needing to be mounted to the outer surface of the fan case 82 can be minimized Moreover, a number of accessory components can be moved inward towards the central axis A of the engine thereby reducing the overall outer diameter and profile of the gas turbine engine without limiting the size of the bypass duct 88.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An accessory drive system for a gas turbine engine comprising:
a first gear box mounted to a fan case of the gas turbine engine, the first gear box driving a first plurality of accessory components; and
a second gear box mounted to a core engine case of the gas turbine engine, the second gear box driving a second plurality of accessory components,
wherein at least one of the first gear box and the second gear box is driven by a respective at least one shaft driven by the gas turbine engine.

2. The accessory drive system as recited in claim 1, including a drive linkage between the first gear box and the second drive gear box, wherein one of the first gear box and the second gear box drives the other gear box through the drive linkage.

3. The accessory drive system as recited in claim 2, wherein the first gear box is driven by the shaft of the gas turbine engine and the second gear box is driven through the drive linkage.

4. The accessory drive system as recited in claim 2, wherein the second gear box is driven by the shaft of the gas turbine engine and the second gear box is driven through the drive linkage.

5. The accessory drive system as recited in claim 1, wherein the shaft driven by the gas turbine engine comprises a first shaft driving the first gear box and a second shaft driving the second gear box.

6. The accessory drive system as recited in claim 1, wherein the second plurality of components driven by the second gear box operate within a second predetermined operating range at a temperature greater than a first predetermined operating range of the first plurality of components driven by the first gear box.

7. The accessory drive system as recited in claim 1, wherein the first plurality of components driven by the first gear box are accessed more frequently than the second plurality of components.

8. A gas turbine engine comprising:
a fan including a plurality of fan blades rotatable about an axis;
a fan case circumscribing the fan;
a core engine section including a core case structure supporting a compressor section, a combustor in fluid communication with the compressor section, a turbine section in fluid communication with the combustor, and a geared architecture driven by the turbine section for rotating the fan about the axis; and
an accessory drive system including a first gear box mounted to the fan case of the gas turbine engine, the first gear box driving a first plurality of accessory components, and a second gear box mounted to the core case structure, the second gear box driving a second plurality of accessory components,
wherein at least one of the first gear box and the second gear box is driven by a respective at least one shaft driven by the core engine section.

9. The gas turbine engine as recited in claim 8, wherein the shaft comprises a tower shaft driven by the turbine section.

10. The gas turbine engine as recited in claim 9, including a drive linkage between the first gear box and the second drive gear box, wherein one of the first gear box and the second gear box drives the other gear box through the drive linkage.

11. The gas turbine engine as recited in claim 10, wherein the first gear box is driven by the shaft of the gas turbine engine and the second gear box is driven through the drive linkage.

12. The gas turbine engine as recited in claim 10, wherein the second gear box is driven by the shaft of the gas turbine engine and the second gear box is driven through the drive linkage.

13. The gas turbine engine as recited in claim 9, wherein the tower shaft driven by the gas turbine engine comprises a first tower shaft driving the first gear box and a second tower shaft driving the second gear box.

14. The gas turbine engine as recited in claim 8, wherein the second plurality of components driven by the second gear box operate within a second predetermined range at a temperature greater than a first predetermined operating range of the first plurality of components driven by the first gear box.

15. The gas turbine engine as recited in claim 8, wherein the first plurality of components driven by the first gear box are accessed more frequently than the second plurality of components.

16. A method of driving accessories of a gas turbine engine comprising:
mounting a first gear box to a fan case of a gas turbine engine;
mounting a second gear box apart from the first gear box to a core engine case structure of the gas turbine engine; and
driving at least one of the first gear box and the second gear box with a respective at least one shaft powered by a shaft of the gas turbine engine.

17. The method as recited in claim 16, including driving one of the first gear box and the second gear box not driven by shaft of the gas turbine engine through a drive linkage between the first gear box and the second gear box.

18. The method as recited in claim 16, including driving a first plurality of components with the first gear box that are accessed more frequently than a second plurality of components driven by the second gear box.

19. The method as recited in claim 16, including driving a second plurality of components with the second gear box that operate within a second predetermined operating range at a temperature greater than a first predetermined operating range of a first plurality of components driven by the first gear box.
